(19) United States
(12) Patent Application Publication
(10) Pub. No.: US 2005/0102887 A1
(43) Pub. Date: May 19, 2005

(54) Rodent trap

(76) Inventors: Jason G. Lang, Inver Grove Heights, MN (US); Thomas D. Nelson, Maplewood, MN (US)

Correspondence Address: IPLM Group, P.A., Post Office Box 18455, Minneapolis, MN, 55418, US

(21) Appl. No.: 10/714,751

(22) Filed: Nov. 17, 2003

(51) Int. Cl. A01M 23/02

(52) U.S. Cl. 43/64

(57) ABSTRACT

A preferred embodiment rodent trap (100, 200) includes a housing (101, 140, 201, 240), a trap assembly (118, 218), and a removable insert receptacle (120, 220). The trap assembly (118, 218) provides access to a cavity (119, 205) within the housing (101, 140, 201, 240). The removable insert receptacle (120, 220) fits within the cavity (119, 205) proximate the trap assembly (118, 218) to contain a rodent or rodents therein. The removable insert receptacle (120, 220) is preferably made of a non-destructible material to prevent escape. Further, the rodent trap (100) includes a base (101), a cover (140), and climbing assisting members (105). The base (101) has a wall portion (102) including an elevated platform (106). The cover (140) cooperates with the base (101) to define a cavity (119), which contains the elevated platform (106). The climbing assisting members (105) provide access to the elevated platform (106). The trap assembly (118) is operatively connected to the elevated platform (106), which elevates the trap assembly (118) within the cavity (119). The base (101), the cover (140), and the elevated platform (106) assist in preventing contaminants from entering the trap assembly (118) and the cavity (119).

### BACKGROUND OF THE INVENTION

1. Field of the Invention

The present invention relates generally to rodent traps and, more particularly, to rodent traps that assist in preventing the escape of rodents contained therein.

2. Description of the Prior Art

Controlling and catching pests, including rodents, is an issue for many facilities, especially for commercial entities in the food industry. Rodents such as mice, rats, and other small vermin carry disease, consume and contaminate foodstuffs, and can damage buildings and various items. Various poisons are known to be effective in controlling rodents, but in many situations it is desirable to use non-toxic suppression methods and/or to ensure that rodents do not die in inaccessible locations where decomposition may cause other unwanted problems. In those situations, devices may be used to capture the rodents without the use of poisons thereby suppressing rodent populations in a controlled fashion that is readily monitored.

Rodents typically prefer to travel along natural runways including intersections of structures such as a wall and a floor or similar structures. Therefore, traps are often placed along such intersections to capture rodents as they travel along the intersections. Additionally, it is desirable to place rodent traps in proximity to points of entry to intercept rodents before or shortly after they enter a facility.

Captured rodents will attempt to escape in any way possible, including gnawing and scratching through obstacles. Many rodent traps are made of plastic because of the ease of manufacture and the lower production cost. However, rodents can gnaw and/or scratch through plastic to escape. Although some traps are made of metal, metal requires multiple manufacturing steps and therefore more labor resulting in higher costs than plastic traps. Therefore, it is desired to have a rodent trap that is easily and inexpensively manufactured and prevents rodents from escaping from the trap. In addition, it is desired to provide easy disposal of the rodents contained within the trap without contacting the rodents or allowing the rodents to escape from the trap during service of the trap.

Rodent traps are often exposed to many types of contaminants such as, but not limited to, cleaning solutions, precipitation, debris, or other contaminants that may render the traps useless. Therefore, it is desired to have a rodent trap that is weather-resistant to protect against such contaminants.

Further, it is often desired to place rodent traps in areas where they cannot be viewed. This is especially true for entities such as restaurants. However, placing rodent traps in such areas often makes inspection of the rodent traps difficult because such areas are typically not easily accessible. Therefore, it is desired to make a rodent trap that is easily accessible and discrete in appearance, whether located inside or outside a building.

The present invention addresses the difficulties of discretely placing traps in proximity to entry points, insuring that traps have a favorable appearance and eliminating the need to come into contact with rodents and their potential for escape during routine service of the traps.

### SUMMARY OF THE INVENTION

A preferred embodiment rodent trap includes a wall portion, a floor portion, a front portion, a top portion, and sides configured and arranged to define a cavity. The wall portion and the front portion are interconnected by the floor portion, the top portion, and the sides. The cavity is between the wall portion and the front portion and is configured and arranged to contain a rodent. A trap assembly provides access to the cavity, and the trap assembly allows the rodent to enter the cavity and prevents the rodent from exiting the cavity. A removable insert receptacle is configured and arranged to be housed within the cavity proximate the trap assembly. The removable insert receptacle is configured and arranged to contain the rodent within the cavity, wherein the removable insert receptacle is made of a non-destructible material thereby preventing escape of the rodent.

A preferred embodiment rodent trap includes a base, a cover, and a trap assembly, and a metal removable insert receptacle. The base has a wall portion operatively connected to a floor portion. The cover has a front portion, a top, and sides. The top and the sides interconnect the wall portion and the front portion, and the base and the cover cooperate to define a cavity therebetween. The trap assembly provides access to the cavity. The metal removable insert receptacle is configured and arranged to fit within the cavity proximate the trap assembly to contain a rodent within the cavity. The metal removable insert receptacle prevents the rodent from gnawing and clawing through the metal removable insert receptacle thereby preventing escape of the rodent.

A preferred embodiment rodent trap includes a housing, a trap assembly, and a removable insert receptacle. The housing includes a cavity, and the trap assembly provides access to the cavity. The removable insert receptacle is configured and arranged to fit within the cavity proximate the trap assembly to contain a rodent. The removable insert receptacle is made of a non-destructible material thereby preventing the rodent from gnawing and clawing through the removable insert receptacle.

A preferred embodiment rodent trap includes a base, a trap assembly, and a housing. The base has a wall portion and a cavity. The wall portion is configured and arranged to be operatively connected to a wall, and the cavity is configured and arranged to contain a rodent. The trap assembly provides access to the cavity. The trap assembly allows the rodent to enter the cavity and prevents the rodent from exiting the cavity. The housing covers the base and has an opening allowing access to the trap assembly and the base. The housing has an appearance resembling a vent, wherein the housing covering the base appears to be a vent operatively connected to the wall.

A preferred embodiment device for trapping a rodent includes a cover, a base, a removable insert receptacle, and a trap assembly. The cover and the base define a cavity and are configured and arranged to resemble a vent operatively connected to a wall. The cover inter-fits on the base. The removable insert receptacle fits inside the cavity and is configured and arranged to contain a rodent within the cavity. The removable insert receptacle is removable from the cavity to assist in readily disposing of the rodent. The trap assembly provides access to the cavity and the removable insert receptacle. The trap assembly allows the rodent to enter the removable insert receptacle within the cavity and prevents the rodent from exiting the removable insert receptacle thereby trapping the rodent within the removable insert receptacle. The cover includes at least one opening to allow access to the trap assembly, the cavity, and the removable insert receptacle.

A preferred embodiment rodent trap includes a base, a cover, a platform, climbing assisting members, and a trap assembly. The base includes a wall portion operatively connected to a floor portion. The cover includes a front portion, a top, and sides. The top and the sides interconnect the wall portion and the front portion, wherein the base and the cover cooperate to define a cavity between the wall portion and the front portion. The cover includes an opening, which allows access to the cavity configured and arranged to contain a rodent. The platform is operatively connected to the wall portion within the cavity, and the platform is elevated with respect to the floor portion. The climbing assisting members extend at an upward angle proximate the floor portion and the opening in the cover to the platform. The climbing assisting members allow the rodent to climb from the floor portion to the platform. The trap assembly is operatively connected to the platform within the cavity proximate the climbing assisting members, and the trap assembly allows the rodent to enter the cavity and prevents the rodent from exiting the cavity. The trap assembly provides an only entrance into the cavity. The platform elevates the trap assembly thereby assisting in preventing contaminants from entering the trap assembly. The cover also assists in preventing contaminants from entering the cavity.

A preferred embodiment rodent trap includes a base, a cover, climbing assisting members, and a trap assembly. The base has a wall portion operatively connected to a floor portion, and the wall portion includes an elevated platform. The cover cooperates with the base to define a cavity, which contains the elevated platform. The climbing assisting members interconnect the floor portion and the elevated platform. The trap assembly is operatively connected to the elevated platform, and the elevated platform elevates the trap assembly within the cavity relative to the floor portion. The base, the cover, and the elevated platform assist in preventing contaminants from entering the trap assembly and the cavity.

A preferred embodiment rodent trap includes a housing, an elevated trap assembly, and climbing assisting members. The housing includes a cavity and an opening. The cavity is configured and arranged to contain a rodent. The elevated trap assembly is contained within the cavity. The opening provides access to the elevated trap assembly, and the elevated trap assembly provides access to the cavity. The trap assembly allows the rodent to enter the cavity and prevents the rodent from exiting the cavity. The climbing assisting members assist the rodent in accessing the trap assembly and entering the cavity. The trap assembly provides an only entrance into the cavity thereby hindering contaminants from entering the cavity through the elevated trap assembly.

### BRIEF DESCRIPTION OF THE DRAWINGS

FIG. 1 is an exploded perspective view of a rodent trap constructed according to the principles of the present invention;

FIG. 2 is a front view of the rodent trap shown in FIG. 1 having an open cover;

FIG. 3 is a side view of the rodent trap having an open cover shown in FIG. 2;

FIG. 4 is a front view of the rodent trap shown in FIG. 1 without a cover;

FIG. 5 is a perspective view of a removable insert receptacle for use with the rodent trap shown in FIG. 1;

FIG. 6 is a side view of the removable insert receptacle shown in FIG. 5;

FIG. 7 is a front view of the rodent trap shown in FIG. 1;

FIG. 8 is a side view of the rodent trap shown in FIG. 1;

FIG. 9 is an exploded perspective view of another rodent trap constructed according to the principles of the present invention;

FIG. 10 is an exploded front view of the rodent trap shown in FIG. 9;

FIG. 11 is an exploded back view of the rodent trap shown in FIG. 9;

FIG. 12 is a bottom view of the rodent trap shown in FIG. 9;

FIG. 13 is an assembled perspective view of the rodent trap shown in FIG. 9; and

FIG. 14 is a perspective view of a removable insert receptacle and an insert member for use with the rodent trap shown in FIG. 1.

### DETAILED DESCRIPTION OF A PREFERRED EMBODIMENT

With reference to the drawings, a preferred embodiment rodent trap constructed according to the principles of the present invention is referenced by the numerals 100 and 200. It is understood that the words rodent and rodents may be used interchangeably herein as the rodent traps 100 and 200 may be used for one or more rodents.

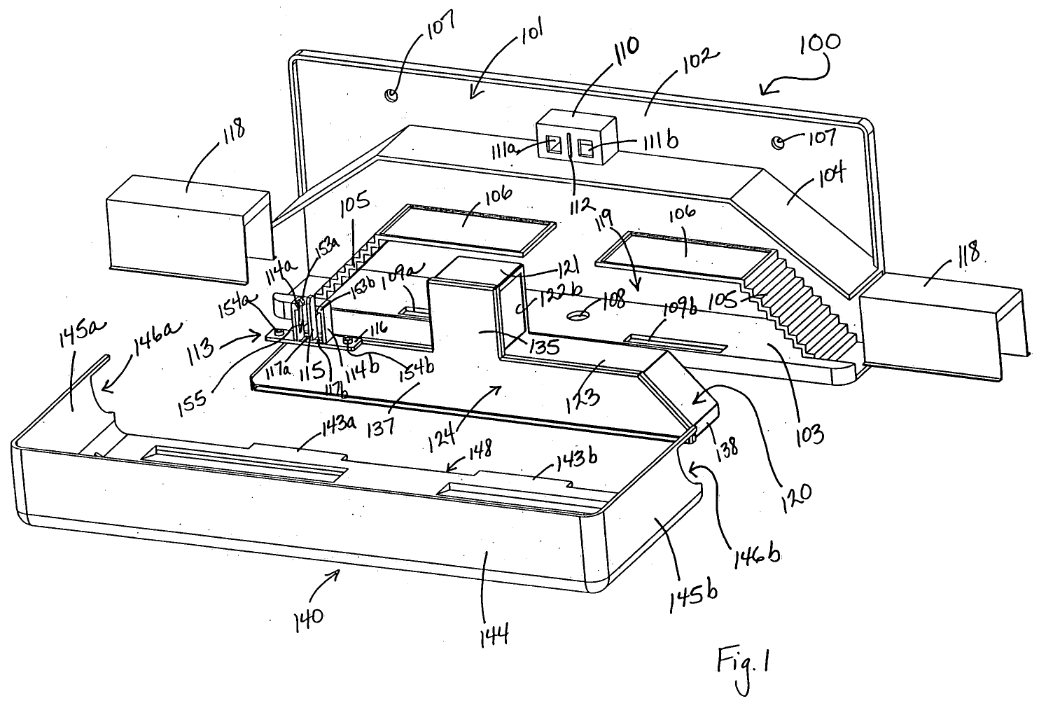

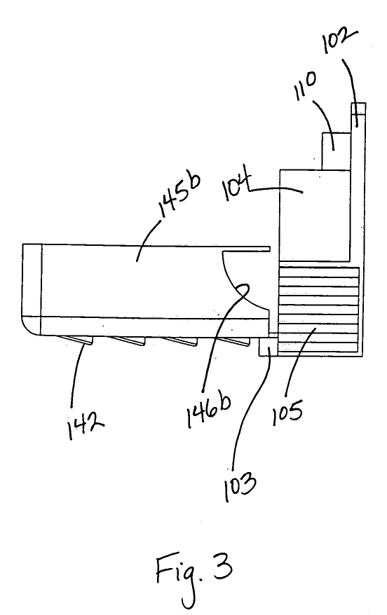

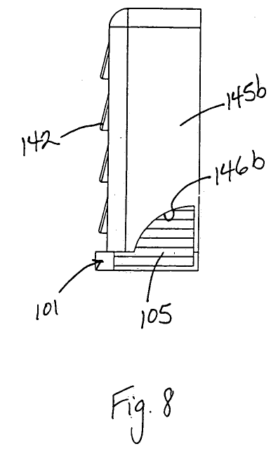

As shown in FIGS. 1-8, a preferred embodiment rodent trap 100 includes a base 101, a trap assembly 118, an insert receptacle 120, and a cover 140. The trap 100 may include a housing, which may include the base 101 and/or the cover 140.

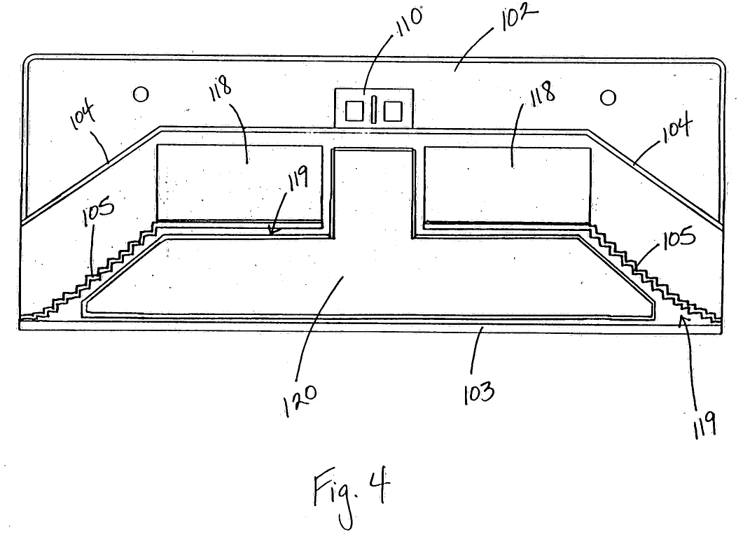

The base 101 includes a wall portion 102 and a floor portion 103, which are preferably operatively connected at an approximately 90° angle to one another and are preferably molded as one piece. The wall portion 102 and the floor portion 103 are preferably configured and arranged to be placed against a wall and a floor, respectively, or similar structures, at the intersection therebetween. An optional ledge 104 protrudes outward from the wall portion 102 proximate a top portion of the wall portion 102. Climbing assisting members 105 are operatively connected to the wall portion 102 and the floor portion 103. Preferably, climbing assisting members 105 begin at each end of the floor portion proximate the wall portion 102 and extend from the wall portion 102 at an upward angle toward the middle of the rodent trap 100. The climbing assisting members 105 are preferably a textured surface such as stairs, but it is recognized that any suitable device to assist the rodents in climbing to an elevated surface such as, but not limited to, a textured ramp could also be used. The climbing assisting members 105 lead upward from each end to a platform 106, which also extends outward from the wall portion 102 and provides an elevated surface upon which a trap assembly 118 is positioned below the ledge 104. This is shown in FIGS. 1 and 4.

The trap assembly 118 is preferably an inclined plane trap assembly, which is well known in the art. Examples of inclined plane trap assemblies that may be used are the TIN CAT™ Repeating Mouse Trap, Model M310, by Woodstream Corporation of Lititz, Pa. and the inclined plane trap assemblies shown and described in U.S. Pat. No. 4,103,448 and in U.S. patent application Ser. Nos. 09/729,832, 10/196,690, 10/383,620, and 10/383,737, which are incorporated by reference herein. Although inclined plane trap assemblies are preferred, any suitable device that allows for the entrance of rodents into the rodent trap 100 and prevents the exit of rodents from the rodent trap 100 may be used.

A trap assembly 118 is placed on each platform 106, and there is a space between the two platforms 106. The space provides an opening into a cavity 119 formed by the floor portion 103, the climbing assisting members 105, the platforms 106, and the trap assemblies 118. The ledge 104 assists in protecting the top of the cavity 119 from the elements and/or other contaminants and provides a ceiling type structure to assist in guiding the rodents in the desired direction toward the center, within the cavity 119, of the trap 100. By guiding the rodents into the cavity 119, which preferably contains the rodents below the trap assemblies 118, with the ledge 104 and the climbing assisting members 104, this helps prevent rodents from getting trapped beneath the inclined plane of the trap assembly 118, which would prevent the inclined plane from pivoting to allow another rodent to enter the trap thereby rendering the trap assembly 118 useless in allowing additional rodents to enter the trap.

The wall portion 102 may also include at least One aperture 107 through which a fastener such as a nail or a screw may be placed to secure the wall portion 101 to a surface such as a wall of a building. An aperture 108 may be included in the floor portion 103 through which a fastener may be placed to secure the floor portion 103 to a surface such as a floor of a building or the ground. It is recognized that any suitable fastener well-known in the art may be used. This secures the trap 100 to prevent it from tipping over or being moved away from the intersection of a wall and a floor or other similar structures.

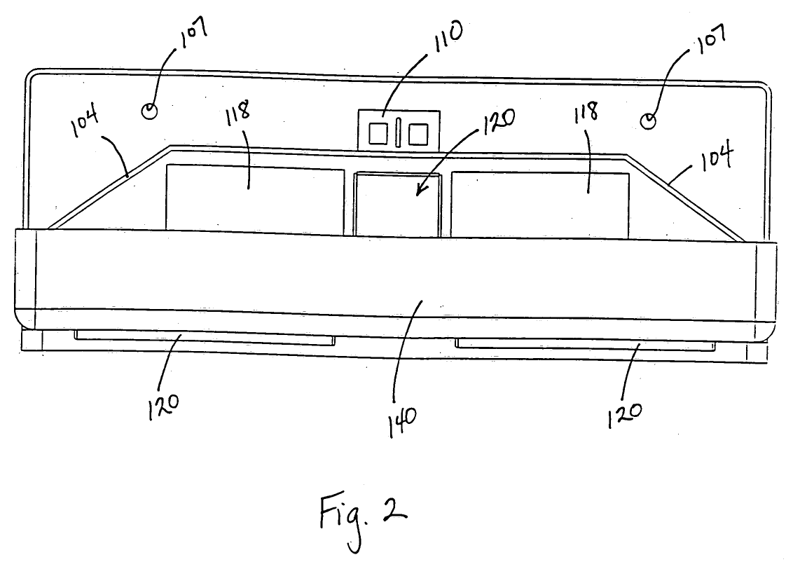

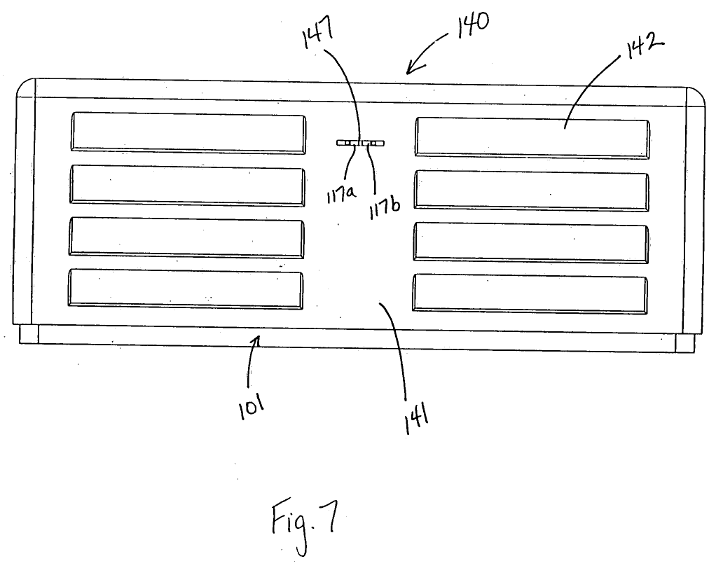

A cover 140 configured and arranged to mate with the base 101 to enclose the cavity 119 includes a front portion 141, a top 144, and sides 145a and 145b. FIGS. 2, 3, 7, and 8 show how the cover 140 mates with the base 101. The cover 140 may have an appearance of a vent such as, but not limited to, an exterior exhaust vent, an exterior utility vent, or an interior heat register. For example, as shown in FIG. 7, the front portion 141 may be made to resemble a vent type structure including louvers 142, which preferably are closed and are not adjustable to reduce any noise, odor, or other nuisance from the trap 100. Preferably, the louvers 142 are molded as extensions of the cover 140 and do not include openings. The front portion 141 may also include an opening 147, which provides access to a locking device. The top 144 is operatively connected to the front portion 141 and envelopes the top of the wall portion 102 of the base 101. The sides 145a and 145b interconnect the front portion 141 and the top 144 along the side of the cover 140 and envelope the sides of the wall portion 102 of the base 101. The sides 145a and 145b includes notches 146a and 146b, respectively, which allow access to the climbing assisting members 105.

The front portion 141 includes a bottom 148 along which optional tabs 143a and 143b extend downward from the front portion 141. The floor portion 103 of the base 101 may also include optional slots 109a and 109b, through which the tabs 143a and 143b are configured and arranged to be inserted to assist in securing the cover 140 to the base 101 proximate the bottom of the trap 100. In addition, the base 101 may include a lock receiver 110, preferably proximate the top of the trap 100. The lock receiver 110 is preferably a rectangular box molded as part of the wall portion 102 proximate between the ledge 104 and the top of the wall portion 102. The lock receiver 110 includes a slot 112 proximate the middle of the lock receiver 110 and an opening 111a on one side of the slot 112 and an opening 111b on the other side of the slot 112.

A lock member 113 includes a base 116, which is preferably a rectangular member having an aperture 154a on one end and an aperture 154b on the other end. A fastener may be used to secure the base 116 to the cover 140 through each aperture 154a and 154b. It is recognized that any suitable means well known in the art may be used to operatively connect the lock member 113 to the cover 140. The lock member 113 is secured to the cover 140 so that it aligns with the lock receiver 110 when the cover 140 is operatively connected to the base 101. The lock member 113 also includes a bar 115 proximate the middle of the lock member 113 and a catch 114a on one side of the bar 115 and a catch 114b on the other side of the bar 115. On each side of the bar 115 is an opening 117a and 117b between the bar 115 and the catch 114a and 114b, respectively. Each catch 114a and 114b includes a deflector 155 on the side of the catch 114a and 114b facing the bar 115. The deflector 155 is preferably proximate the middle of the catch 114a and 114b, as shown on catch 114a in FIG. 1. Although the deflector 155 is only shown on catch 114a, it is recognized that the catch 114b also includes a deflector. Each catch 114a and 114b includes a latch 153a and 153b, respectively, proximate the end extending outward toward the bar 115. The latches 153a and 153b are configured and arranged to fit within the respective openings 111a and 111b and engage the lock receiver 110. Therefore, the cover 140 is locked onto the base 101 when the catches 114a and 114b have been inserted into the openings 111a and 111b. The bar 115 is inserted into the slot 112 to guide the catches 114a and 114b into the openings 111a and 111b.

Each prong of a two-prong key (not shown) may be inserted into the openings 117a and 117b to release the lock member 113 from the lock receiver 110. As each prong of the key is inserted into each respective opening 117a and 117b, each prong contacts each respective deflector 155 and deflects each latch 153a and 153b from the lock receiver 110 thereby allowing the catches 114a and 114b to be slid out of the openings 111a and 111b. An example of a similar locking device that could also be used is disclosed in U.S. Pat. Nos. 5,806,237 and 6,370,813, which are incorporated by reference herein.

An optional removable insert receptacle 120 is configured and arranged to fit within the cavity 119, as shown in FIG. 4. Preferably, the insert receptacle 120 is a generally upside down T-shaped box made of a non-destructible material such as metal or some other type of material through which a rodent cannot gnaw or scratch through to escape.

The insert receptacle 120 includes a top portion 121 and a base portion 123, which form the generally upside down T-shaped box to accommodate the general shape of the cavity 119. The base portion 123 is preferably generally rectangular in shape and includes a top 129 to which the top portion 121 is operatively connected proximate the middle of the top 129. A bottom 132 is preferably longer than the top 129 and sides 138 extend upward therefrom. Sides 130 are angled from the top 129 downward to interconnect the sides 138 to the top 129. A back 131 encloses the back of the base portion 123 and interconnects the top 129, the bottom 132, the sides 130, and the sides 138 to form a cavity 134. The top 129, the bottom 132, the sides 130, and the sides 138 form an opening 133 proximate the front of the base portion 123, and the opening 133 provides access to the cavity 134.

The top portion 121 is preferably generally square in shape and includes a top 127, a back 128, and sides 126a and 126b that form part of the cavity 134 and the opening 133 into the cavity 134. The back 128 is preferably an extension of the back 131 of the base portion 123 and the sides 126a and 126b are operatively connected to the top 129 of the base portion 123. The side 126a includes an opening 122a and the side 126b includes an opening 122b. Openings 122a and 122b align with the trap assemblies 118 and provide access to the cavity 134.

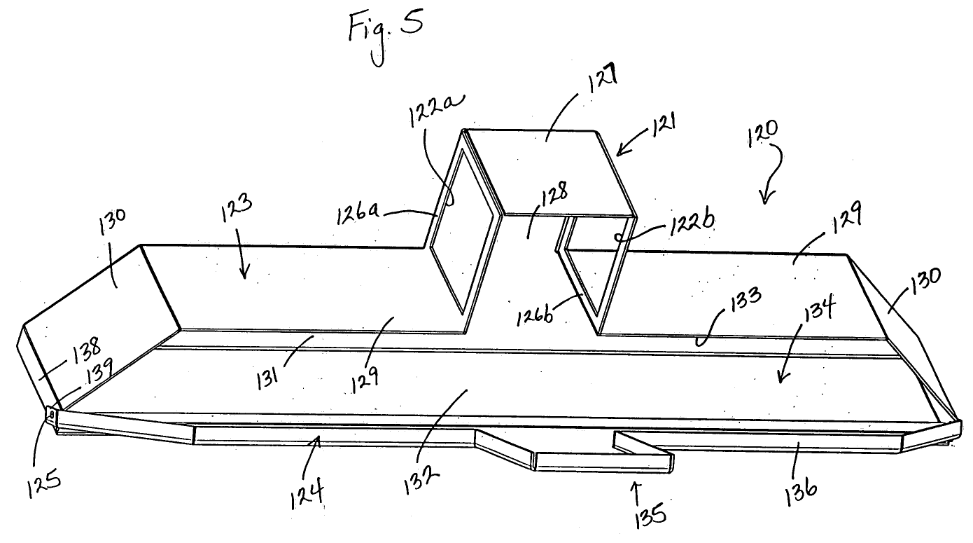

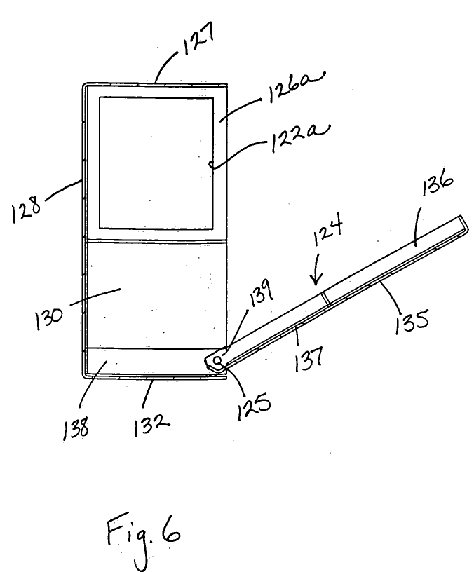

A cover 124 is configured and arranged to enclose the opening 133, as shown in FIGS. 5 and 6. The cover 124 includes a top portion 135 extending upward from a base portion 137 configured and arranged to enclose the opening 133 formed by the top portion 121 and the base portion 123, respectively. A flange 136 extends from the outer perimeter of the top portion 135 and the base portion 137 to envelope the outer perimeter of the top portion 121 and the base portion 123 thereby covering the opening 133. A hinge 125 operatively connects the sides 138 to the sides 139 thereby allowing the cover 124 to be opened to allow access to the opening 133.

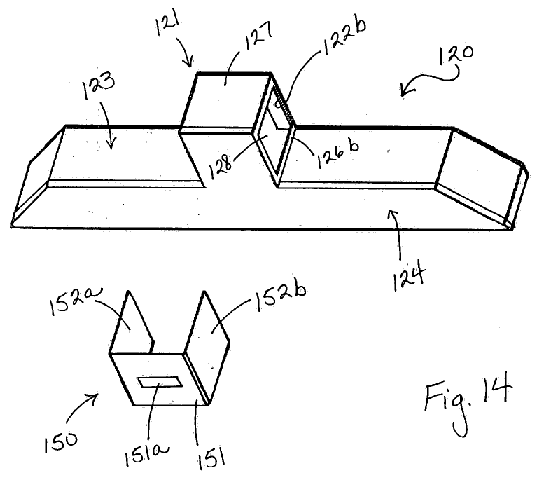

An optional insert member 150 may be used to cover the openings 122a and 122b of the insert receptacle 120, as shown in FIG. 14, during servicing of the trap 100 to assist in preventing escape. The insert member 150 includes a front portion 151 having a handle 151a and sides 152a and 152b. The front portion 151 is configured and arranged to fit about the cover 124 and the top portion 121, and the sides 152a and 152b are configured and arranged to cover openings 122a and 122b, respectively, when the insert member 150 is slide into place about the insert receptacle 120. The handle 151a may be used to place the insert member 150 about the insert receptacle 120.

Although the preferred embodiment insert receptacle 120 is a generally T-shaped box, it is recognized that any suitable shape may be used as long as the insert receptacle is configured and arranged to contain a rodent within a cavity of a trap to prevent the rodent from gnawing or scratching through the trap and escaping. In addition, it is recognized that the insert member 150 may also be any suitable shape configured and arranged to accommodate the shape of the insert receptacle 120.

In operation, the trap 100 is preferably secured to a wall and/or a floor or other similar structure proximate the intersection therebetween. This ensures that the trap 100 is not accidentally moved away from the intersection. Preferably, fasteners such as screws are inserted through apertures 107 and/or apertures 108 to secure the wall portion 102 and/or the floor portion 103 to a wall or a floor, respectively. The insert receptacle 120 is placed within the cavity 119 of the trap 100. Optionally, a glue board may be placed within the insert receptacle 120. Also optionally, an attractant, a bait, and/or an odor masking agent may be placed within the insert receptacle 120.

The cover 140 is secured to the base 101 by placing the tabs 143a and 143b into the slots 109a and 109b, respectively, and then inserting the lock member 113 into the lock receiver 110. As a rodent moves along the intersection between the wall and the floor, the rodent goes through the notch 146a or 146b, climbs the climbing assisting members 105, and enters the trap assembly 118. The rodent is then trapped within the trap assembly 118 and goes through the opening 122a or 122b into the cavity 134 of the insert receptacle 120. The rodent is then contained within the cavity 134. During inspection of the trap 100, the trap is unlocked by inserting a key into the opening 147 of the cover 140 to release the lock member 113 from the lock receiver 110 as previously described. The cover 140 may then be detached from the base 101, and the insert receptacle 120 may be removed from the cavity 119.

Optionally, before the insert receptacle 120 is removed from the cavity 119, the insert member 150 may be placed about the insert receptacle 120 to cover the openings 122a and 122b. Preferably, the handle 151a is grasped to position the front portion 151 about the cover 124 and the top portion 121 of the insert receptacle 120 and the sides 152a and 152 proximate the openings 122a and 122b, respectively. The sides 152a and 152b cover the openings 122a and 122b, respectively thereby preventing escape from the openings 122a and 122b as the insert receptacle 120 is removed from the cavity 119. After the insert receptacle 120 and the insert member 150 are taken to a desired location for disposal of the rodents contained therein, the insert receptacle 120 may then be opened and the rodents disposed by methods well known in the art. The base 101 does not have to be detached from the wall and/or floor or other similar structure. The insert receptacle 120 may also be removed for baiting, scenting, and/or cleaning the trap 100 without detaching the base 101 from the wall and/or floor or other similar structure.

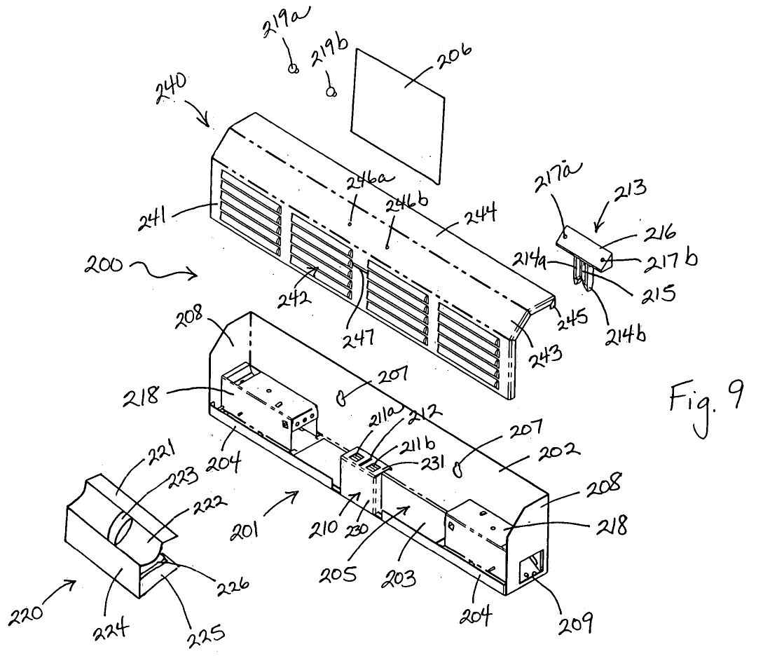

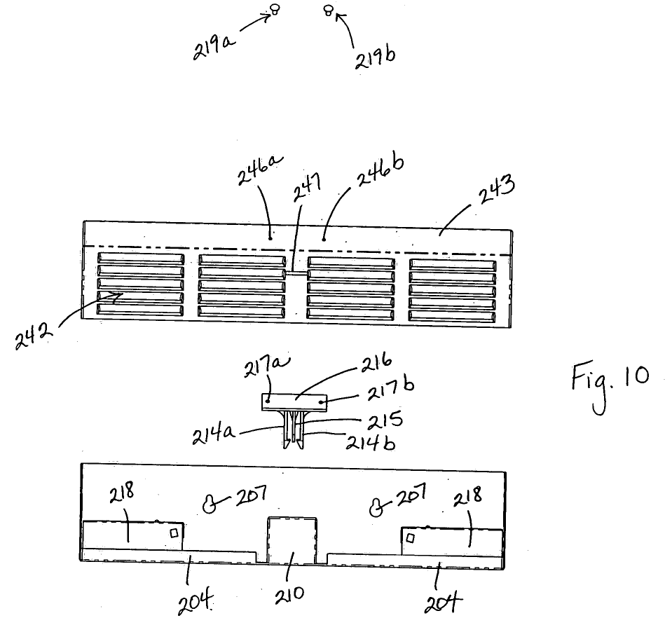

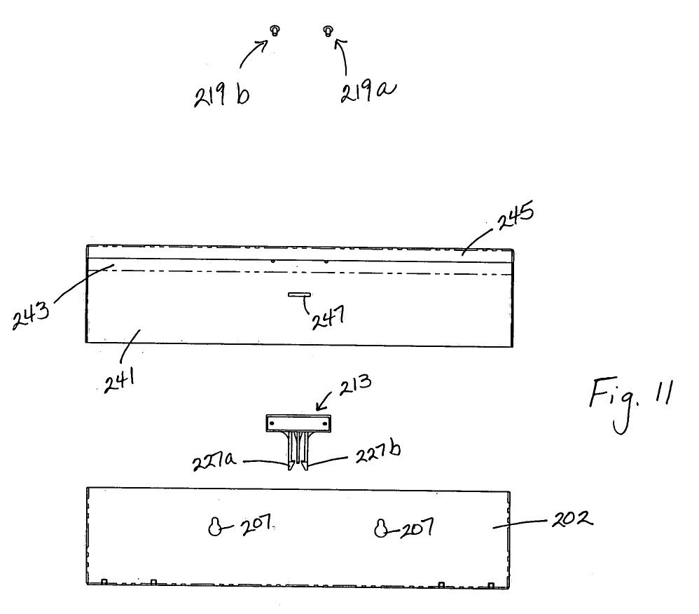

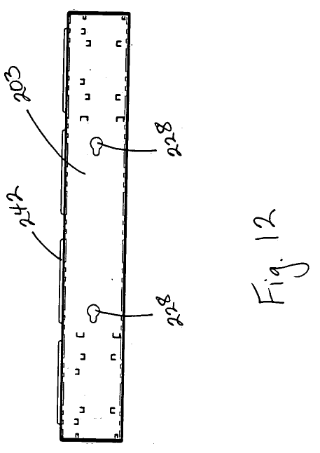

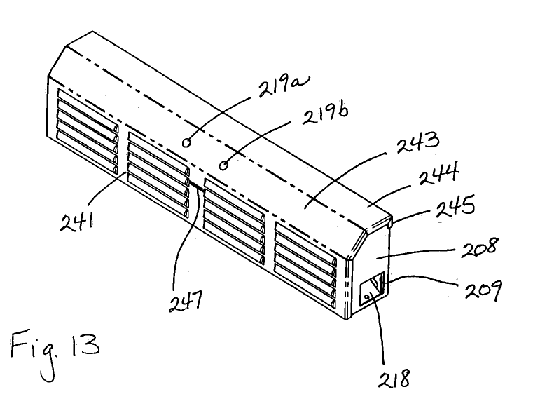

As shown in FIGS. 9-13, a preferred embodiment rodent trap 200 includes a base 201 and a cover 240. The base 201 includes a wall portion 202 and a floor portion 203, which are preferably operatively connected at an approximately 90° angle to one another and are configured and arranged to be placed against a wall and a floor, respectively, or similar structures, at the intersection therebetween. Sides 208 enclose each end of the base 201 and operatively connect the sides of the wall portion 202 and the floor portion 203 proximate each end of the base 201. Each side 208 includes an opening 209. The side of the floor portion 203 opposite the wall portion 202 includes a barrier wall portion 204 proximate each end of the base 201 and extending inward toward the center of the floor portion 203. A lock receiver 210 is operatively connected to the floor portion 203 between the barrier wall portions 204 proximate the center of the floor portion 203. A passage 205 is defined along the floor portion 203 between the wall portion 202 and the barrier wall portions 204 and between the wall portion 202 and the lock receiver 210. An inclined plane trap assembly 218 is preferably placed proximate each opening 209 within the passage 205 so that the trap assemblies 218 allow access from the openings 209 into the passage 205. This is shown in FIG. 13. A service maintenance card 206 such as an inspection calendar may be attached to the wall portion 202 proximate the passage 205. The wall portion 202 may include apertures 207 through which fasteners may be inserted to attach the wall portion 202 to a surface. The floor portion 203 may include apertures 228, as shown in FIG. 12, through which fasteners may be inserted to attach the floor portion 203 to a surface. It is recognized that any suitable fastener well-known in the art may be used.

The lock receiver 210 is preferably an upside down L-shaped member having a base 230 extending upward from the floor portion 203 and a top 231 extending toward the wall portion 202. The top 231 includes a slot 212 proximate the center and openings 211a and 211b, one on either side of the slot 212.

A lock member 213 is configured and arranged to engage the lock receiver 210 to lock the trap 200. The lock member 213 includes a base 216, which preferably has three sides and a right triangular shaped cross section. One side includes a bar 215 extending downward proximate the center of the side and catches 214a and 214b extending downward, one on each side of the bar 215. Each catch 214a and 214b includes a latch 227a and 227b, respectively, proximate the end extending outward toward the bar 215. The latches 227a and 227b are configured and arranged to fit within the respective openings 211a and 211b to engage the lock receiver 210. Therefore, the cover 240 is locked onto the base 201 when catches 214a and 214b have been inserted into openings 211a and 211b. The bar 215 is inserted into the slot 212 to guide the catches 214a and 214b into the openings 211a and 211b. On the side that is the hypotenuse are openings 217a and 217b, through which fasteners 219a and 219b may be inserted to secure the lock member 213 onto the cover 240 through apertures 246a and 246b. The lock member 213 is secured to the cover 240 so that it aligns with the lock receiver 210 when the cover 240 is operatively connected to the base 201.

The cover 240 is preferably configured and arranged to resemble a vent and includes a front portion 241, an angled portion 243, a top 244, and a back portion 245. The front portion 241 includes louvers 242, which are preferably closed and not adjustable to reduce noise, odor, or other nuisance from the trap 200. Preferably, the louvers 242 are molded as extensions of the cover 240 and do not include openings. The angled portion 243 interconnects the front portion 241 and the top 244, and the back portion 245 extends downward from the top 244. The cover 240 mates with the base 201 to enclose the passage 205 and create a cavity therein. The front portion 241 interconnects the floor portion 203 and the sides 208, the angled portion 243 interconnects the sides 208, the top 244 interconnects the sides 208 and the wall portion 202, and the back portion 245 extends along the top of the wall portion 202. The angled portion 243 includes apertures 246a and 246b through which fasteners 219a and 219b are inserted to operatively connect the cover 240 to the lock member 213 via openings 217a and 217b, respectively. Alternatively, rather than including openings 217a and 217b, the lock member 213 could include pegs extending outward therefrom in alignment with apertures 246a and 246b and could be inserted and operatively connected thereto in a rivet-like fashion. It is recognized that any suitable means well known in the art may be used to operatively connect the lock member 213 to the cover 240. Proximate the middle and the top of the front portion 241 is an opening 247 providing access to the lock member 213. A key (not shown) may be inserted through the opening 247 to unlock and release the cover 240 from the base 201 for inspection of the interior of the trap 200.

An optional insert receptacle 220 is configured and arranged to fit within the passage 205. The preferred shape of the insert receptacle 220 is generally a “C” shape having a first side 221, a top 222, a second side 224, and a bottom 225. The first side 221 is operatively connected to the top 222 and the second side 224 interconnects the top 222 and the bottom 225. There is preferably no connection between the first side 221 and the bottom 225, thereby forming the “C” shape, but it is recognized that there could be such a connection. Proximate the center of the top 222 is a handle 223, which is formed by making two parallel cuts generally perpendicular to the intersection of the top 222 and the sides 221 and 224. The portion between the two cuts is pulled upward to form the handle 223 and the portions on either side of the handle 223 are preferably pushed downward thereby creating recessed portions on either side of the handle 223. An optional glue board 226 may be placed along the bottom 225. The insert receptacle 220 is preferably made of metal or another suitable material well known in the art through which a rodent cannot gnaw or scratch to escape. When inserted into the passage 205 of the trap 200, the second side 224 preferably encloses the passage on the side opposite the wall portion 202 thereby containing the rodent between the wall portion 202 and the second side 224. In the event the cover 240 is made of plastic or some other material through which a rodent can escape, the insert receptacle 220 prevents a rodent from escaping through the cover 240.

In operation, the trap 200 is preferably secured to a wall and/or a floor or other similar structure proximate the intersection therebetween. Preferably, fasteners such as screws are inserted through apertures 207 and/or apertures 228 to secure the wall portion 202 and/or the floor portion 203 to a wall or a floor, respectively. The insert receptacle 220 is placed within the passage 205 of the trap 200. Optionally, a glue board 226 may be placed within the insert receptacle 220. Also optionally, an attractant, a bait, and/or an odor masking agent may be placed within the insert receptacle 120. The cover 240 is secured to the base 201 by inserting the lock member 213 into the lock receiver 210. As a rodent moves along the intersection between the wall and the floor, the rodent goes through the opening 209 and enters the trap assembly 218. The rodent is then trapped within the trap assembly 218 and enters the insert receptacle 220 within the passage 205. The rodent is then contained within the passage 205. During inspection of the trap 200, the trap is unlocked by inserting a key into the opening 247 of the cover 240 to release the lock member 213 from the lock receiver 210 as previously described. The cover 240 may then be detached from the base 201, and the insert receptacle 220 may be removed from the passage 205. The insert receptacle 220 may then be opened and the rodents may be disposed by methods well known in the art. The base 201 does not have to be detached from the wall and/or floor or other similar structure. The insert receptacle 220 may also be removed for baiting, scenting, and/or cleaning the trap 200 without detaching the base 201 from the wall and/or floor or other similar structure.

The insert receptacle of the present invention may be configured and arranged for use with any type of rodent trap. The insert receptacle enhances the efficacy of the trap in reducing the number of escapes. The insert receptacle also increases the durability of the trap because rodents cannot gnaw and/or scratch through the insert receptacle thereby increasing the number of times the trap may be used. Examples of traps that may be used include, but are not limited to, KWIK-KATCH manufactured by Gremar, Inc. of West Des Moines, Iowa, Bell 24/7 manufactured by Bell Laboratories, Inc. of Madison, Wis., and Victor POLYCAT manufactured by Woodstream Corporation of Lititz, Pa.

Another benefit to using the insert receptacle is that there may be apertures in the insert receptacle that allow for easily determining whether rodents are contained within the insert receptacle. The rodents are contained within the insert receptacle during inspection of the trap because the rodents cannot escape from the insert receptacle as the cover of the trap is opened. As the insert-receptacle is being removed from the cavity, the openings of the insert receptacle no longer align with the trap assemblies but the incidence of escape is decreased. With the use of the insert member, the rodents cannot escape from the insert receptacle as the insert receptacle is being removed from the cavity because the openings of the insert receptacle are covered. Further, when using the insert receptacle, disposal of the rodents contained therein is easier because the insert receptacle is removed from the cavity rather than picking up the entire trap, the insert receptacle is opened, and the rodents are released from therein without contacting the rodents. The rodents may then be disposed by methods well known in the art.

In addition to using an insert receptacle, a glue board may be added to assist in preventing escape of the rodents. The glue board may be placed within the insert receptacle to prevent the rodent from moving around within the insert receptacle. The glue board and the rodent may be easily disposed by sliding them out of the insert receptacle. This reduces possible contact with the rodent during disposal because the rodent will be stuck onto the glue board and will not be crawling out of the insert receptacle as it is opened.

Because traps may be used either indoors or outdoors, protecting the traps from the environment is often desirable. For example, the traps may be exposed to cleaning solutions, precipitation, debris, or other contaminants that may render the traps useless. If the traps were to become flooded with any one of a number of contaminants, the insert receptacle and/or the trap assemblies would be rendered useless in trapping rodents. Therefore, making the traps weather-resistant from such contaminants is desirable. Elevating the trap assemblies and adequately covering the cavities in which the insert receptacles and trap assemblies are placed helps to make the traps weather-resistant. For example, elevating the trap assemblies helps prevent flooding of the trap assemblies and providing a ledge and/or a cover with a limited number of apertures helps prevent contaminants from entering the cavity. Further, providing apertures or openings in the bottoms of the traps allows for drainage should contaminants enter the traps.

In addition, making the traps tamper-resistant and secure also helps to make the traps weather-resistant. The locking devices on the traps help ensure that the covers cannot be easily removed from the bases of the traps to expose the interior components to contaminants such as moisture and debris. The traps cannot be easily opened by wind, by the rodents, by stepping on the traps, or by other casual abuse. Securing the traps to a wall or a floor or other similar structure assists in preventing the traps from being tipped over or moved from the desired location thereby making the traps more effective since rodents prefer to travel along intersections. The traps may be held in place against the structure by screws, adhesive, or other securing means well known in the art. However, the traps may be opened easily and quickly by authorized personnel. Making the traps weather-resistant also protects the optional glue boards from such contaminants.

Keeping records of maintenance has been a problem with conventional stations since the records are typically kept on maintenance cards affixed to either the exterior or the interior of the stations. The maintenance cards may be labels with adhesive backing, cards inserted into a holder, or other types of maintenance cards well-known in the art. The maintenance cards may not be easily accessible, they may fall off, or they become illegible due to exposure to various elements, contaminants, and/or the rodents. If located on the exterior of the station, the maintenance card may be exposed to weathering, precipitation, grease, cleaning solutions, etc. If located on the interior of the station, the maintenance card may be exposed to dirt or grime carried in by the rodents or the rodents may gnaw and/or scratch on the maintenance card to make the maintenance card illegible.

A discrete appearance for a rodent trap is important in many situations. For example, having a rodent trap visible against a wall next to a table in a restaurant may not be very appetizing to the patrons. Therefore, disguising the rodent trap to appear like an interior heat vent would provide a more discrete appearance less likely to be noticeable to patrons. Other types of vents or devices normally located at the intersection of a wall and a floor or other similar structures may also be used.

The above specification, examples and data provide a complete description of the manufacture and use of the composition of the invention. Since many embodiments of the invention can be made without departing from the spirit and scope of the invention, the invention resides in the claims hereinafter appended.

1. A rodent trap, comprising:
a) a wall portion, a floor portion, a front portion, a top portion, and sides configured and arranged to define a cavity, said wall portion and said front portion being interconnected by said floor portion, said top portion, and said sides;
b) said cavity being between said wall portion and said front portion and configured and arranged to contain a rodent;
c) a trap assembly providing access to said cavity, said trap assembly allowing the rodent to enter said cavity and preventing the rodent from exiting said cavity; and
d) a removable insert receptacle configured and arranged to be housed within said cavity proximate said trap assembly, said removable insert receptacle being configured and arranged to contain the rodent within said cavity, wherein said removable insert receptacle is made of a non-destructible material thereby preventing escape of the rodent.

2. The rodent trap of claim 1, wherein said removable insert receptacle is made of metal.

3. The rodent trap of claim 1, further comprising a glue board contained within said removable insert receptacle, said glue board trapping the rodent within said removable insert receptacle.

4. The rodent trap of claim 1, further comprising climbing assisting members interconnecting said floor portion and said trap assembly, said climbing assisting members being positioned between said wall portion and said front portion, between said floor portion and said top portion, and between said sides and being enclosed therebetween, said trap assembly being elevated and said climbing assisting members assisting the rodent in accessing said trap assembly and entering said cavity, wherein said trap assembly provides an only entrance into said cavity thereby hindering contaminants from entering said cavity through said elevated trap assembly.

5. The rodent trap of claim 1, further comprising a maintenance card within said cavity, wherein said removable insert receptacle prevents the rodent from contacting said maintenance card, and wherein said maintenance card is protected from contaminants.

6. The rodent trap of claim 1, wherein said front portion has an appearance of a vent and said wall portion is operatively connected to a wall of a building.

7. The rodent trap of claim 1, further comprising:
a) an opening in said removable insert receptacle proximate said trap assembly; and
b) an insert member configured and arranged to cover said opening in said removable insert receptacle, wherein said insert member prevents escape from said removable insert receptacle when placed about said removable insert receptacle and said removable insert receptacle is removed from said cavity.

8. A rodent trap, comprising:
a) a base having a wall portion operatively connected to a floor portion;
b) a cover having a front portion, a top, and sides, said top and said sides interconnecting said wall portion and said front portion, wherein said base and said cover cooperate to define a cavity therebetween, said cavity being configured and arranged to contain a rodent between said base and said cover;
c) a trap assembly providing access to said cavity; and
d) a metal removable insert receptacle configured and arranged to fit within said cavity proximate said trap assembly to contain a rodent within said cavity, said metal removable insert receptacle preventing the rodent from gnawing and clawing through said metal removable insert receptacle thereby preventing escape of the rodent.

9. The rodent trap of claim 8, wherein said base and said cover are operatively connected to a building and have an appearance resembling a vent.

10. The rodent trap of claim 8, further comprising a glue board contained within said metal removable insert receptacle, said glue board trapping the rodent within said metal removable insert receptacle.

11. The rodent trap of claim 8, further comprising a maintenance card within said cavity, wherein said metal removable insert receptacle prevents the rodent from contacting said maintenance card, and wherein said maintenance card is protected from contaminants.

12. A rodent trap, comprising:
a) a housing including a cavity configured and arranged to contain a rodent within said housing;
b) a trap assembly providing access to said cavity; and
c) a removable insert receptacle configured and arranged to fit within said cavity proximate said trap assembly to contain a rodent, said removable insert receptacle being made of a non-destructible material thereby preventing the rodent from gnawing and clawing through said removable insert receptacle.

13. The rodent trap of claim 12, wherein said housing includes a base and a cover.

14. The rodent trap of claim 12, wherein said housing is configured and arranged for attachment to a structure and has an appearance of a vent attached to the structure.

15. The rodent trap of claim 12, wherein said removable insert receptacle is made of metal.

16. The rodent trap of claim 12, further comprising climbing assisting members, said climbing assisting members being positioned between said wall portion and said front portion, between said floor portion and said top portion, and between said sides and being enclosed therebetween, wherein said trap assembly is elevated, said climbing assisting members interconnecting said housing and said trap assembly and assisting the rodent in accessing said trap assembly and entering said cavity, wherein said trap assembly provides an only entrance into said cavity thereby hindering contaminants from entering said cavity.

17. The rodent trap of claim 12, further comprising a maintenance card within said cavity, wherein said removable insert receptacle prevents the rodent from contacting said maintenance card, and wherein said maintenance card is protected from contaminants.

18. A rodent trap, comprising:
a) a base having a wall portion and a cavity, said wall portion being configured and arranged to be operatively connected to a wall;
b) a trap assembly providing access to said cavity, said trap assembly allowing the rodent to enter said cavity and preventing the rodent from exiting said cavity; and
c) a housing covering said base and having an opening allowing access to said trap assembly and said cavity, said housing enclosing said cavity to contain a rodent within said cavity, said housing having an appearance resembling a vent, wherein said housing covering said base appears to be a vent operatively connected to the wall.

19. The rodent trap of claim 18, wherein said housing appears to be an interior heat vent.

20. The rodent trap of claim 18, wherein said housing appears to be an exterior exhaust vent.

21. The rodent trap of claim 18, further comprising a removable insert receptacle configured and arranged to fit within said cavity proximate said trap assembly to contain the rodent, said removable insert receptacle being made of a non-destructible material thereby preventing the rodent from gnawing and clawing through said removable insert receptacle.

22. The rodent trap of claim 21, wherein said removable insert receptacle is made of metal.

23. A device for trapping a rodent, comprising:
a) a cover and a base defining a cavity and configured and arranged to resemble a vent operatively connected to a wall, said cover inter-fitting on said base;
b) a removable insert receptacle inside said cavity, said removable insert receptacle being configured and arranged to contain a rodent within said cavity, said removable insert receptacle being removable from said cavity to assist in readily disposing of the rodent;
c) a trap assembly providing access to said cavity and said removable insert receptacle, said trap assembly allowing the rodent to enter said removable insert receptacle within said cavity and preventing the rodent from exiting said removable insert receptacle thereby trapping the rodent within said removable insert receptacle; and
d) at least one opening in said cover allowing access to said trap assembly, said cavity, and said removable insert receptacle.

24. The device of claim 23, wherein the removable insert receptacle is made of a non-destructible material through which the rodent is unable to gnaw and claw to escape therefrom.

25. The device of claim 23, wherein said cover resembles an exterior vent.

26. The device of claim 25, wherein said cover resembles an exhaust vent.

27. The device of claim 23, wherein said cover resembles an interior vent.

28. The device of claim 27, wherein said cover resembles a heat vent.

29. A rodent trap, comprising:
a) a base including a wall portion operatively connected to a floor portion;
b) a cover including a front portion, a top, and sides, said top and said sides interconnecting said wall portion and said front portion, wherein said base and said cover cooperate to define a cavity between said wall portion and said front portion, said cover including an opening allowing access to said cavity, said cavity being configured and arranged to contain a rodent;
c) a platform operatively connected to said wall portion within said cavity, said platform being elevated with respect to said floor portion;
d) climbing assisting members extending at an upward angle proximate said floor portion and said opting in said cover to said platform, said climbing assisting members allowing the rodent to climb from said floor portion to said platform; and
e) a trap assembly operatively connected to said platform within said cavity proximate said climbing assisting members, said trap assembly allowing the rodent to enter said cavity and preventing the rodent from exiting said cavity, said trap assembly providing an only entrance into said cavity, said platform elevating said trap assembly thereby assisting in preventing contaminants from entering said trap assembly, said cover also assisting in preventing contaminants from entering said cavity.

30. The rodent trap of claim 29, further comprising a lock member operatively connected to said cover and a lock receiver operatively connected to said base, said lock member engaging said lock receiver when said cover is operatively connected to said base thereby releasably locking said cover to said base.

31. The rodent trap of claim 29, wherein said wall portion includes an aperture through which a fastener is inserted to secure said wall portion to a wall.

32. The rodent trap of claim 29, wherein said floor portion includes an aperture through which a fastener is inserted to secure said floor portion to a floor.

33. The rodent trap of claim 29, further comprising a ledge operatively connected to said base above said platform, said ledge and said cover assisting in preventing contaminants from entering said trap assembly and said cavity.

34. The rodent trap of claim 29, further comprising a removable insert receptacle configured and arranged to fit within said cavity, said trap assembly providing access to said removable insert receptacle, said removable insert receptacle containing the rodent within the cavity and being made of a non-destructible material thereby preventing escape of the rodent.

35. The rodent trap of claim 34, further comprising a maintenance card within said cavity, wherein said cover and said removable insert receptacle prevent contaminants from contacting said maintenance card.

36. The rodent trap of claim 29, wherein said cover has an appearance of a vent.

37. A rodent trap, comprising:
a) a base having a wall portion operatively connected to a floor portion, said wall portion including an elevated platform;
b) a cover cooperating with said base to define a cavity, said cavity containing said elevated platform;
c) climbing assisting members interconnecting said floor portion and said elevated platform; and
d) a trap assembly operatively connected to said elevated platform, said elevated platform elevating said trap assembly within said cavity relative to said floor portion, wherein said base, said cover, and said elevated platform assist in preventing contaminants from entering said trap assembly and said cavity.

38. The rodent trap of claim 37, wherein said cover has an appearance resembling a vent.

39. The rodent trap of claim 37, further comprising a ledge operatively connected to said base above said platform, said ledge and said cover assisting in preventing contaminants from entering said trap assembly and said cavity.

40. The rodent trap of claim 37, further comprising a lock member operatively connected to said cover and a lock receiver operatively connected to said base, said lock member engaging said lock receiver when said cover is operatively connected to said base thereby releasably locking said cover to said base.

41. The rodent trap of claim 37, further comprising a removable insert receptacle configured and arranged to fit within said cavity, said trap assembly providing access to said removable insert receptacle, said removable insert receptacle containing the rodent within the cavity and being made of a non-destructible material thereby preventing escape of the rodent.

42. The rodent trap of claim 41, further comprising a maintenance card within said cavity, wherein said cover and said removable insert receptacle prevent contaminants from contacting said maintenance card.

43. A rodent trap, comprising:
a) a housing including a cavity and an opening, said cavity being configured and arranged to contain a rodent;
b) an elevated trap assembly contained within said cavity, said opening providing access to said elevated trap assembly and said elevated trap assembly providing access to said cavity, said trap assembly allowing the rodent to enter said cavity and preventing the rodent from exiting said cavity; and
c) climbing assisting members assisting the rodent in accessing said trap assembly and entering said cavity, wherein said trap assembly provides an only entrance into said cavity thereby hindering contaminants from entering said cavity through said elevated trap assembly.

44. The rodent trap of claim 43, wherein said housing includes an aperture through which a fastener is inserted to operatively connect said housing to a structure.

45. The rodent trap of claim 44, wherein said housing has an appearance of a vent attached to the structure.

46. The rodent trap of claim 43, wherein said housing includes a base and a cover.

47. The rodent trap of claim 46, further comprising a lock member operatively connected to said cover and a lock receiver operatively connected to said base, said lock member engaging said lock receiver when said cover is operatively connected to said base thereby releasably locking said cover to said base.

48. The rodent trap of claim 43, further comprising a removable insert receptacle configured and arranged to fit within said cavity, said elevated trap assembly providing access to said removable insert receptacle, said removable insert receptacle containing the rodent within the cavity and being made of a non-destructible material thereby preventing escape of the rodent.

49. A method of trapping a rodent, comprising:
a) providing a rodent trap including a base, a cover, an elevated trap assembly, and climbing assisting members, the base and the cover cooperating to define a cavity therebetween, the cavity configured and arranged to contain a rodent between the base and the cover, the cover including an opening proximate a bottom portion of the cover, the elevated trap assembly being between the base and the cover and being elevated relative to the bottom portion of the cover, the elevated trap assembly providing an only entrance into the cavity, the climbing assisting members extending upward proximate the opening of the cover to proximate the elevated trap assembly between the base and the cover; and
b) the rodent entering the rodent trap through the opening in the cover, climbing the climbing assisting members, entering and going through the elevated trap assembly, entering the cavity and being trapped within the cavity by the elevated trap assembly, the rodent being trapped within the cavity until the cover is removed from the base of the rodent trap.

50. The method of claim 49, the base, the cover, and the climbing assisting members of the rodent trap hindering contaminants from entering the elevated tap assembly and the cavity.

51. The method of claim 49, the base being operatively connected to a wall of a building and the cover having an appearance of a vent.
